(19) United States
(12) Patent Application Publication
(10) Pub. No.: US 2012/0054628 A1
(43) Pub. Date: Mar. 1, 2012

(54) Top200RX

(76) Inventor: Omega Arteaga-Gamboa, Fair Oaks Ranch, TX (US)

(21) Appl. No.: 12/963,550

(22) Filed: Dec. 8, 2010

Related U.S. Application Data
(60) Provisional application No. 61/267,521, filed on Dec. 8, 2009.

(51) Int. Cl. G06F 3/01

(52) U.S. Cl. 715/738

(57) ABSTRACT

A method and system for placing a request for prescription medication information via the World Wide Web. The request is placed by a user at a client system and received by a server system. The server system receives client information including identification of the client system. The server system then assigns a client identifier to the client system and associates the assigned client identifier with the received user information. The server system sends to the client system the requested prescription medication information and an HTML document identifying the information and including a one touch button. The client system then receives the requested prescription medication information and displays the HTML document. The server system receives the request and combines the client system identifier of the client system to generate usage reports based on the user selection of the prescription medication monograph at the touch of a button.

### 1. CROSS-REFERENCE TO RELATED APPLICATION

Top200Rx claims filed provisional patent application No. 61/267,521 on Dec. 08, 2009.

### 2. STATEMENT REGARDING FEDERALLY SPONSORED RESEARCH OR DEVELOPMENT

“Not Applicable”

### 3. REFERENCE TO SEQUENCE LISTING, A TABLE, OR A COMPUTER PROGRAM LISTING COMPACT DISC APPENDIX

“Not Applicable”

### 4. BACKGROUND OF THE INVENTION

The interne comprises a vast number of computers and computer networks that are interconnected through communication links that allow the exchange of information using services such as World Wide Web (“WWW”). The Web allows a server computer system or web site to send graphical web pages of information to a remote client computer system. The remote client computer can then display the Web pages specified through the Uniform Resource Locator (“URL”). The client computer system receives the Web page through the designated browser. The World Wide Web is conducive to the information that Top200Rx provides to clients. Currently, prescription medication information is only available through the printed information sheets included with prescription fills at the pharmacy. This approach will allow direct to consumer information access. Internet access grants portability world-wide and creates health care information access to even underserved populations or disaster driven catastrophic locations.

Electronically we are able to market and sell our product. Electronically we are able to update and provide clients with current and up-to-date information. Our product includes prescription medication monographs unique to specific designated pharmaceutical drugs. The server computer system provides an electronic version of our database. Clients are able to browse through our database and select the specific pharmaceutical drug monograph required. When the user has completed selecting the monograph the information is displayed using Hyper-Text markup Language (“HTML”). The HTML document contains various tags that control the displaying of text, graphics, and other features. Once the specific monograph is displayed, the computer system then prompts the user to make another selection if required. No personal information is gathered which could cause security concerns.

USPTO has granted Top200Rx with a Registered Trademark, Reg. No. 3,832,504, dated Aug. 10, 2010

### 5. SUMMARY OF THE INVENTION

An embodiment of the present invention provides a method and system for prescription medication information monograph access from a client system. Each interne based client is provided an identifier that identifies a client. The client system displays information that identifies the monographs and through a single action of a mouse click the client selects the identified monograph. The server system uses the identifier to identify information needed to generate reports for client such as name of monograph selected, number of times monographs were selected and language in which the monograph was selected for use.

### 6. BRIEF DESCRIPTION OF THE DRAWINGS

FIG. 1 a Illustrate single action selection in one embodiment of the present invention.

FIG. 2 Is a block diagram illustrating an embodiment of the present invention.

FIG. 3 Is a flow diagram of routine that enables the single-action selection for user.

### 7. DETAILED DESCRIPTION OF THE INVENTION

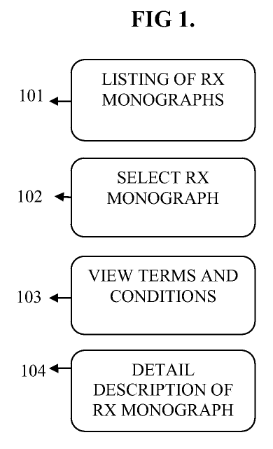

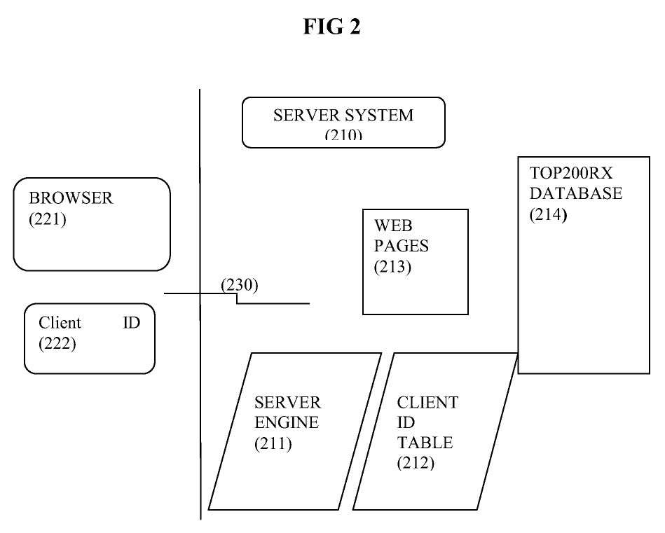

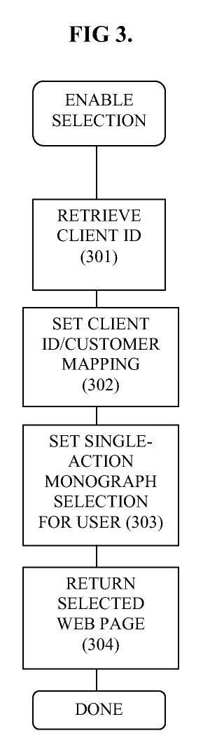

The present invention provides a method and system for the selection of prescription medication monographs in a client/server environment. The current pharmacy consult does not provide a system available to the end user that provides simple easy to access prescription medication information at the touch of a button. The present invention method and system for the selection of prescription medication monographs (public placed kiosks or web based access) augments the pharmacist consult. Currently, the user is given clinically written information sheets that do not address the need for low literacy users. In one act, “Touch of a button” the server system collects information selected and identifies the client system. The server system determines the client system and maps the information to the specific client for database report usage. The server system sends the requested information (e.g., via a Web page) to the client computer system. Thus, once the description of a selected monograph is displayed, the user need only take a single action to view that monograph. The user can view and select more than one monograph to view via the interne through the client server. Also, since the monograph is selected from an already identified client server there is no need to collect any further sensitive or secure information to be transmitted via the internet. FIG. 1 illustrates single action request in one embodiment of the present invention. FIG. 1 illustrates display of a web page describing an Rx monograph that may be selected. This Web page was sent from the server system to the client system when the user requested to review detailed information about the Rx monograph. This Web page contains a listing of Rx monographs (101), a single action selection section (102), a view terms and conditions section (103), and a detailed view of the Rx monograph selected. These sections can be omitted, rearranged or adapted in various ways. The use need only be aware of the Rx monograph selected by a single action. The listing of Rx monographs and the selection sections provide information that identifies the monograph selected. The server system adds the summary description, the detailed description and the sections selected to the Web page for viewing. The server system only adds the single action item requested. This single-action selection section allows the user to specify with a single click of a mouse button the Rx monograph item selected. FIG. 2 is a block diagram illustrating an embodiment of the present invention. This embodiment supports the single-action selection over the Internet using the World Wide Web. The server system (210) includes a server engine 211, a client identifier/customer table (212), various Web pages (213), and a customer database (214). The server engine receives HTTP request to access Web pages identified by the URLs and provides the Web pages to the various client systems. Such an HTTP request may indicate that the purchase has performed the single action to effect selection. The client identifier includes information such as the name of the client and location. FIG. 3 is a flow diagram of a routine 4 that enables one touch of a button selection for a user. To enable single-action selection, a server system needs to have information about the client ID. In step 301 the server system retrieves the client identifier that was sent by the client system. In step 302 the server system updates the client identifier to indicate that the generated client identifier has been associated with that client. In step 303, the server system sets an indicator that selection is enabled for the client identifier.

That identifier may be stored in the identifier/customer table. In step 304, the server system supplies a confirming Web page to the client system.

We claim:

1. A method of selecting a prescription medication monograph under control of a client system, displaying information identifying the prescription medication monograph; and in response to only a single action being performed, sending a request to access the monograph selected along, under control of a single-action selection component of the server system, receiving the request; retrieving additional client system information to complete monograph selection.

2. The method of claim 1 wherein the displaying of the prescription medication information includes displaying information indicating the single action.

3. The method of claim 1 wherein the single action is clicking/touch of a button.

4. The method of claim 1 wherein a user of the client system does not need to explicitly identify themselves when placing a selection for the prescription medication monograph.

5. A client system for selecting prescription monograph information
a. Display component for displaying information identifying the monograph;
a. Single-action selection component that in response to performance of only a single action, sends a request to a server system to select the identified monograph, the request including the identifier so that the server system can locate additional information needed to complete the selection and so that the server system can fulfill the generated selection to complete selection of monograph.

6. The client system of claim 5 wherein the display component is a browser.

7. The client system of claim 5 wherein the predefined action is the clicking/touch of a button.

8. A server system for generating a monograph selection comprising;
